(19) United States
(12) Patent Application Publication
(10) Pub. No.: US 2008/0293301 A1
(43) Pub. Date: Nov. 27, 2008

(54) Electrical connector with anti-twist shield

(75) Inventors: Richard Elof Hamner, Hummelstown, PA (US); Justin Shane McClellan, Camp Hill, PA (US); Jason M'Cheyne Reisinger, Carlisle, PA (US)

Correspondence Address: Robert J. Kapalka;Tyco Electronics Corporation, Suite 140, 4550 New Linden Hill Road, Wilmington, DE, 19808-2952, US

(73) Assignee: Tyco Electronics Corporation

(21) Appl. No.: 11/805,809

(22) Filed: May 24, 2007

(51) Int. Cl. H01R 13/648

(52) U.S. Cl. 439/607

(57) ABSTRACT

A shielded electrical connector includes an insulative housing having a receptacle therein. A shield is mounted on the housing. The shield has a protrusion formed thereon that is received in the receptacle. The protrusion engages a surface on the housing to minimize relative motion between the shield and the housing. The shield includes a shroud and the protrusion is located on the shroud. The receptacle is located proximate a mating end of the housing. The shield includes a mounting tab for mounting the connector to a panel.

### BACKGROUND OF THE INVENTION

The invention relates generally to electrical connectors and, more particularly, to shielded electrical connectors.

There is an increasing demand for digital content in today's society in both the home and the workplace, due at least in part to the proliferation of electronic devices such as computers, set top boxes, game box converters, etc. Such devices typically include internal connectors at input/output ports such as, for example, Hi-Definition Multimedia Interface (HDMI) connectors and Serial Advanced Technology Attachment (SATA) and External SATA or eSATA. HDMI is a transmission interface developed for multimedia audio video systems including DVD players, game box converters, TV set top boxes, and the like. SATA and eSATA define standards primarily for disk drives, or more generally data storage solutions, for personal computers. The connectors are typically mounted at the edge of circuit boards to facilitate access of cable mounted external connectors to the internal circuits of the host devices.

At least some internal connectors include a shield that acts as a shroud at the mating end of the connector that receives the mating end of a mating external connector. Such shields typically include a mounting flange that is configured to receive a fastener such as a mounting screw to mount the shield to a panel. However, as torque is applied to the mounting screw, the shield may rotate or twist relative to the connector housing thereby potentially preventing successful mating with the mating connector.

Thus, there is an ongoing need for a shielded connector assembly wherein relative movement of the shield with respect to the connector is minimized.

### BRIEF DESCRIPTION OF THE INVENTION

In one embodiment, a shielded electrical connector is provided. The connector includes an insulative housing having a receptacle therein. A shield is mounted on the housing. The shield has a protrusion formed thereon that is received in the receptacle. The protrusion engages a surface on the housing to minimize relative motion between the shield and the housing.

Optionally, the receptacle is formed in a side wall of the housing. Alternatively, the receptacle may be formed in an upper wall of the housing. The shield includes a shroud and the protrusion is located on the shroud. The receptacle is located proximate a mating end of the housing. The shield includes a mounting tab for mounting the connector to a panel.

In another embodiment, a shielded electrical connector is provided that includes an insulative housing having a pair of receptacles formed therein. A shield is mounted on the housing. The shield has a pair of protrusions formed thereon that are received in a respective one of the receptacles. The protrusions and the receptacles cooperate to key and stabilize the shield on the housing.

### BRIEF DESCRIPTION OF THE DRAWINGS

FIG. 1 is a perspective view of a connector assembly including a shield formed in accordance with an exemplary embodiment of the present invention.

FIG. 2 is a perspective fragmentary view of the mating end of the connector housing shown in FIG. 1.

FIG. 3 is a perspective fragmentary view of the shield shown in FIG. 1.

FIG. 4 is a perspective fragmentary view of the mating end of a connector housing formed in accordance with an alternative embodiment of the present invention.

FIG. 5 is a perspective fragmentary view of a shield formed in accordance with an alternative embodiment of the present invention.

FIG. 6 is a perspective fragmentary view of the mating end of a connector housing formed in accordance with a third embodiment of the present invention.

FIG. 7 is a perspective fragmentary view of a shield formed in accordance with a third embodiment of the present invention.

### DETAILED DESCRIPTION OF THE INVENTION

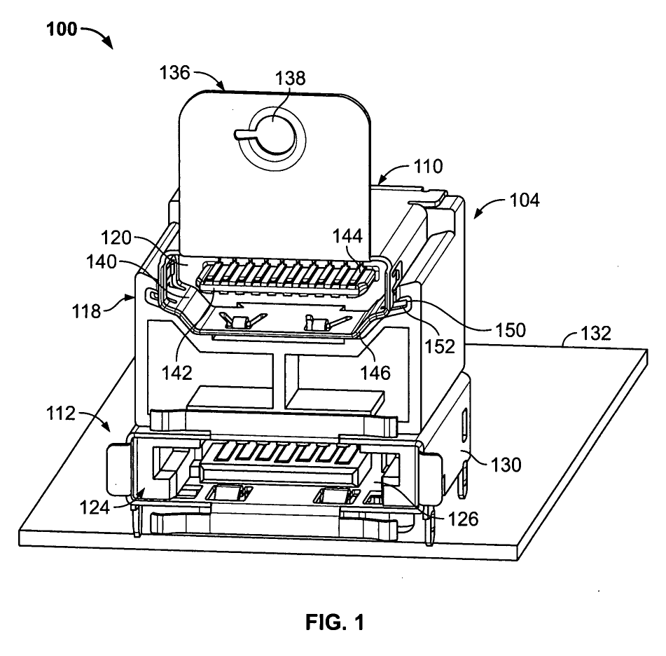

FIG. 1 illustrates a connector assembly 100 including a connector 104 and shield 110 formed in accordance with an exemplary embodiment of the present invention. As illustrated, the connector assembly 100 includes the connector 104 and a second connector 112 that are placed in a stacked arrangement with the connector 104 positioned above the second or lower connector 112. In one embodiment, the lower connector 112 may comprise an eSATA connector and the connector 104 may comprise an HDMI connector. It is to be understood, however, that this implementation is set forth by way of example only, and that other applications of the inventive concepts herein are also contemplated. For instance, the connectors 104 and 112 may be any type of shielded connectors configured for attachment to a panel. Alternatively, the inventive concepts presented herein may be applied to any shielded connector to stabilize the shield on the connector. More particularly, the shield 110 may be mounted on a single connector that is a separate component of an electrical system.

The connector 104 includes a housing 118 having a contact area 120. The shield 110 is mounted on the housing 118 and surrounds the contact area 120. The lower connector 112 includes a lower housing 124 having a contact area 126. A lower shield 130 surrounds the contact area 126 of the lower connector 112. The connector assembly 100 is configured to be mounted on a circuit board 132. In one application, the assembly 100 may be used in a device such as a set top box (not shown), and the shield 110 is provided with a mounting tab 136 to mount the assembly 100 to a panel on the box. The mounting tab 136 is provided with an attachment hole 138 that receives a fastener (not shown) for securing the connector assembly 100 to the panel. In an exemplary embodiment, the attachment hole 138 is formed with a stamped thread for convenient screw attachment to the panel.

The lower shield 130 is mounted on the circuit board 132 and may be electrically connected to ground circuits on the circuit board 132. The shield 110 includes a rear panel (not shown) that is electrically connected to the lower shield 130 to thereby ground the shield 110. When used with a separate connector, the shield 110 is mounted directly on the circuit board 132. The shield 110 and the housing 118 include features that cooperate to minimize movement of the shield 110 relative to the housing 118 as torque is applied to a fastener (not shown) when the assembly 100 is mounted to the panel as will be described. The description that follows will focus on a connector such as the connector 104 and a shield such as the shield 110.

The housing 118 has a mating end 140 that includes a tongue 142. Electrical contacts 144 are positioned on at least one of the upper and lower surfaces of the tongue 142. The shield 110 includes a shroud 146 that surrounds the mating end 140 of the housing 118 such that a mating connector (not shown) is received within the shroud 146 when being mated to the connector 104. Protrusions 150 are formed on opposite sides of the shield 110. The housing 118 includes receptacles 152 that are sized to receive the protrusions 150 when the shield 110 is mounted on the housing 118. The protrusions 150 and the receptacles 152 cooperate to inhibit relative movement between the shield 110 and the housing 118.

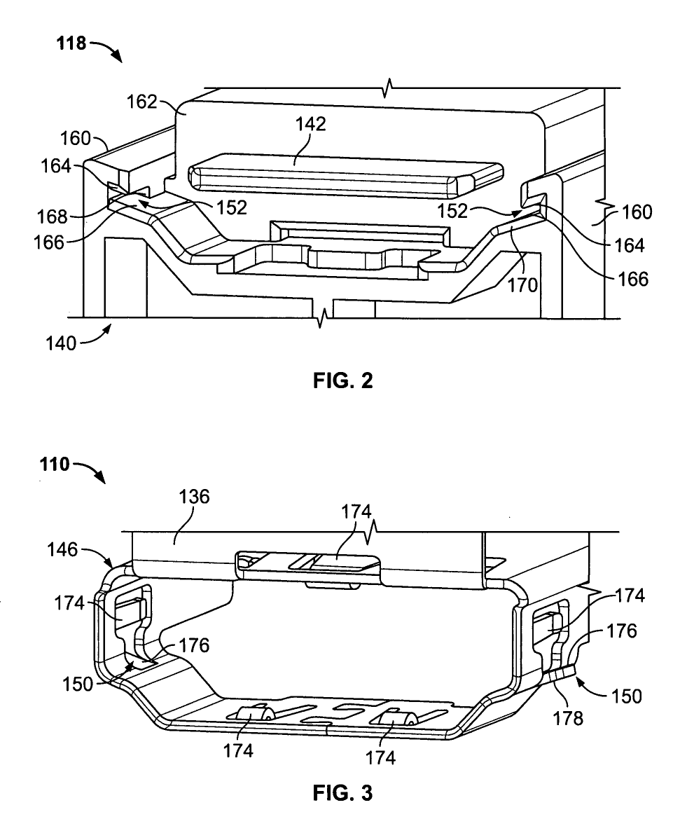

FIG. 2 illustrates a perspective fragmentary view of the mating end 140 of the housing 118. FIG. 3 illustrates a perspective fragmentary view of the shield 110. The housing 118 is fabricated from an insulative material and includes side walls 160 that extend to the mating end 140 of the housing 118. The tongue 142 extends from a back wall 162. Each receptacle 152 comprises a channel 152 formed in an interior side of the side walls 160. The channels 152 include interior engagement surfaces 164 and 166. The channels 152 extend rearwardly to rearward channel walls 168, only one of which is visible in FIG. 2. Beveled surfaces 170 are provided at the connector mating end 140 to provide a lead in for positioning the shield 110 on the housing 118.

When mated on the housing 118, the shroud 146 of the shield 110 receives the mating connector (not shown). A plurality of spring fingers 174 are formed on the shroud 146 to apply normal forces on the mating connector to retain the mating connector. The protrusions 150 are wing-shaped and extend laterally from opposite sides of the shroud 146. The protrusions 150 are received in the channels 152 when the shield 110 is mounted on the housing 118. The protrusions 150 include upper and lower surfaces 176 and 178 respectively that engage the interior engagement surfaces 164 and 166 of the channels 152 to minimize movement, and in particular rotational movement, of the shield 110 relative to the housing 118. In the illustrated embodiment, the protrusions 150 are snugly received in the channels 152 to stabilize the shield 110 on the housing 118.

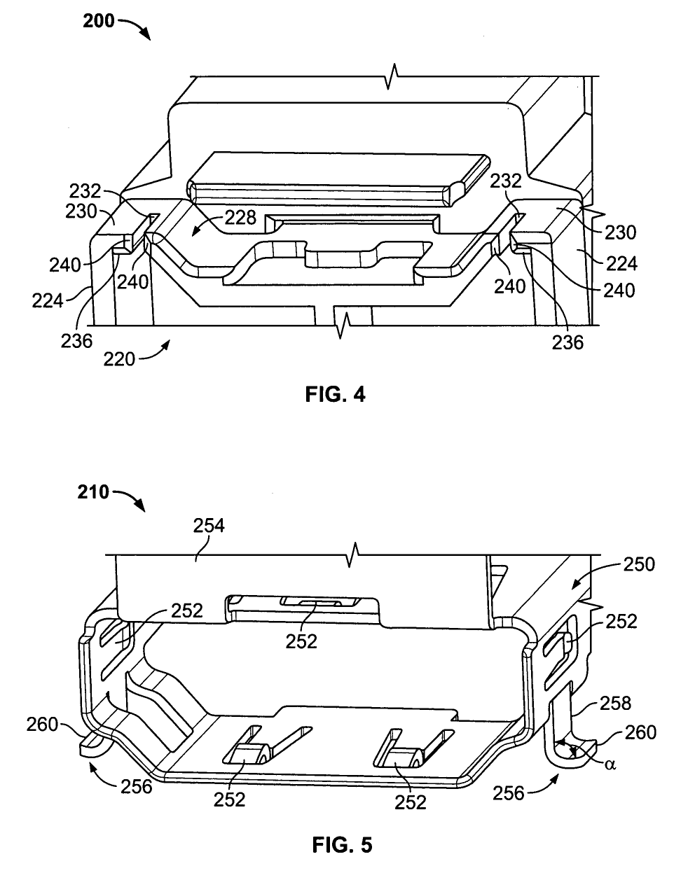

FIG. 4 is a perspective fragmentary view of a connector housing 200 formed in accordance with an alternative embodiment of the present invention. FIG. 5 is a perspective fragmentary view of a shield 210 configured to be used with the connector housing 200. The housing 200 has a mating end 220. The housing 200 is fabricated from an insulative material and includes side walls 224 that extend to the mating end 220 of the housing 200. A contoured upper wall 228 interconnects the side walls 224 and includes end portions 230 that join to the side walls 224. Slots 232 are formed in the contoured upper wall 228. The slots 232 extend rearwardly from the mating end 220 of the housing 200 and define ledges 236 adjacent the slots 232. The slots 232 include beveled edges 240 at the mating end 220.

The shield 210 includes a shroud 250 that receives a mating connector (not shown) when the shield 210 is mounted on the housing 200. Spring fingers 252 are formed on the shroud 250 to apply normal forces to the mating connector to retain the mating connector. A mounting tab 254 is provided for mounting the housing 200 and shield 210 to a panel (not shown). Protrusions 256 extend from opposite sides of the shroud 250. Each protrusion 256 includes a section 258 that extends vertically downward from the shroud 250. The protrusion 256 terminates with a lip 260 that is formed at an angle α to the downwardly extending section 258. In one embodiment, the lip 260 and the section 258 are substantially perpendicular to one another. When the shield 210 is mounted on the housing 200, the downwardly extending section 258 of the protrusion 256 is received in the slot 232 with the lip 260 in abutting engagement with the ledge 236 on the housing 200. Through the engagement of the lip 260 with the ledge 236, movement, and in particular rotational movement, between the housing 200 and the shield 210 is minimized. The protrusion 256 and the slot 232 also cooperate to locate and stabilize the shield 210 on the housing 200.

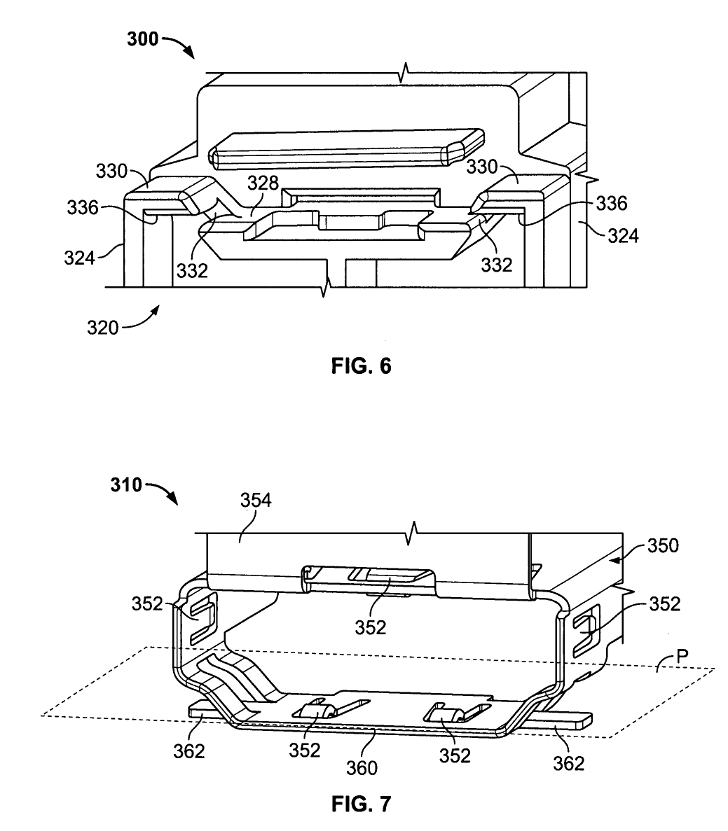

FIG. 6 is a perspective fragmentary view of a connector housing 300 formed in accordance with an alternative embodiment of the present invention. FIG. 7 is a perspective fragmentary view of a shield 310 configured to be used with the connector housing 300. The housing 300 has a mating end 320. The housing 300 includes side walls 324 that extend to the mating end 320 of the housing 300. A contoured upper wall 328 interconnects the side walls 324 and includes end portions 330 that join to the side walls 324. Slots 332 are formed in the contoured upper wall 328. The slots 332 are positioned such that ledges 336 are formed on the underside of the end portions 330. The ledges 336 are adjacent to the slots 332.

The shield 310 includes a shroud 350 that receives a mating connector (not shown) when the shield 310 is mounted on the housing 300. Spring fingers 352 are formed on the shroud 350 to apply normal forces to the mating connector to retain the mating connector. A mounting tab 354 is provided for mounting the shield 310 and housing 300 to a panel (not shown). The shroud 350 includes a base 360 that lies in a plane P. Wing-like protrusions 362 extend from opposite sides of the shroud 350. The protrusions 362 extend and lie in the plane P of the shroud base 360. When the shield 310 is mounted on the housing 300, the protrusions 362 extend beneath the end portions 330 and are placed in abutting engagement with the ledges 336 on the housing 300. In this manner, movement, and in particular rotational movement, between the housing 300 and the shield 310 is minimized.

It is to be understood that other variations of the previously described embodiments of the invention are contemplated. For instance, protrusions may be formed on or extend from any shield or shroud surface that may engage the connector housing. Moreover, the protrusions on the shield need not be symmetric for a given connector. That is, protrusions may have different geometries may be used in combination along with complementary receptacles on the connector housing thereby keying the shield to the housing.

The embodiments herein described provide an electrical connector for mounting to a panel that includes a shield that minimizes rotational movement or twisting between the shield and the connector housing. The shield includes protrusions that are received in receptacles in the connector housing. In this manner misalignment or mis-mating resulting from mounting torque applied to mount the connector to a panel is minimized.

While the invention has been described in terms of various specific embodiments, those skilled in the art will recognize that the invention can be practiced with modification within the spirit and scope of the claims.

What is claimed is:

1. A shielded electrical connector comprising:
an insulative housing having a receptacle formed therein; and
a shield mounted on said housing, said shield having a protrusion formed thereon that is received in said receptacle, said protrusion engaging a surface on said housing to minimize relative motion between said shield and said housing.

2. The shielded connector of claim 1, wherein said receptacle is formed in a side wall of said housing.

3. The shielded connector of claim 1, wherein said receptacle is formed in an upper wall of said housing.

4. The shielded connector of claim 1, wherein said shield includes a shroud and said protrusion is located on said shroud.

5. The shielded connector of claim 1, wherein said receptacle is located proximate a mating end of said housing.

6. The shielded connector of claim 1, wherein said shield includes a mounting tab for mounting the connector to a panel.

7. The shielded connector of claim 1, wherein said protrusion comprises a wing that extends from said shield.

8. The shielded connector of claim 1, wherein said housing includes a ledge and a slot and said protrusion comprises an L-shaped member including a vertically extending section that is received in said slot and a lip that engages said ledge.

9. The shielded connector of claim 1, wherein said shield includes a shroud having a base defining a plane and said protrusion comprises a wing laterally extending in the plane of said base of said shroud.

10. A shielded electrical connector comprising:
an insulative housing having a pair of receptacles formed therein; and
a shield mounted on said housing, said shield having a pair of protrusions formed thereon and received in a respective one of said receptacles, and wherein said protrusions and said receptacles cooperate to key and stabilize said shield on said housing.

11. The shielded connector of claim 10, wherein one of said protrusions has a first geometry and the other of said protrusions has a second geometry different from the first geometry.

12. The shielded connector of claim 10, wherein said receptacles comprise channels formed in a side wall of said housing.

13. The shielded connector of claim 10, wherein said receptacles are formed in an upper wall of said housing.

14. The shielded connector of claim 10, wherein said shield includes a shroud and said protrusions are located on said shroud.

15. The shielded connector of claim 10, wherein said receptacles are located proximate a mating end of said housing.

16. The shielded connector of claim 10, wherein said shield includes a mounting tab for mounting the connector to a panel.

17. The shielded connector of claim 10, wherein at least one of said protrusions comprises a wing that extends from said shield.

18. The shielded connector of claim 10, wherein said housing includes a ledge and a slot and at least one of said protrusions comprises an L-shaped member including a vertically extending section that is received in said slot and a lip that engages said ledge.

19. The shielded connector of claim 10, wherein said shield includes a shroud having a base defining a plane and at least one of said protrusions comprises a wing laterally extending in the plane of said base of said shroud.
